(19) United States
(12) Patent Application Publication
(10) Pub. No.: US 2005/0275502 A1
(43) Pub. Date: Dec. 15, 2005

(54) Method for manufacturing a thin-layer component, in particular a thin-layer, high-pressure sensor, and thin-layer component

(76) Inventors: Herbert Goebel, Reutlingen (DE); Harald Wanka, Reutlingen (DE); Andre Kretschmann, Reutlingen (DE); Ralf Henn, Stuttgart (DE); Joachim Gluck, Renningen (DE); Horst Muenzel, Clayton (AU)

Correspondence Address: KENYON & KENYON, ONE BROADWAY, NEW YORK, NY, 10004, US

(21) Appl. No.: 11/147,496

(22) Filed: Jun. 7, 2005

Related U.S. Application Data
(62) Division of application No. 10/343,210, filed on Jul. 29, 2003.

(30) Foreign Application Priority Data
Jul. 26, 2000 (DE) 100 36 285.0
Jul. 24, 2001 (DE) 101 35 216

(51) Int. Cl. H01C 10/10

(52) U.S. Cl. 338/42

(57) ABSTRACT

Proposed is a method for manufacturing a thin-layer component, in particular a thin-layer, high-pressure sensor, as well as a thin-layer component, where a resistive layer for forming measuring elements, in particular strain gauges, is deposited on an electrically non-conductive surface of a diaphragm layer, a contact-layer system for electrically contacting the measuring elements being deposited on the measuring elements in such a manner, that regions of the measuring elements are situated between each region of the contact-layer system and the diaphragm layer. This is used to provide, in particular, a high-pressure sensor, in which the capacitances of the contacts of the contact-layer system are designed to be symmetric.

### CROSS-REFERENCE TO RELATED APPLICATIONS

This application is a division of U.S. patent application Ser. No. 10/343,210, which was the National Stage of PCT International Application No. PCT/DE01/02768 filed Jul. 25, 2001, each of which is expressly incorporated herein in its entirety by reference thereto.

### FIELD OF THE INVENTION

The present invention relates to a method for manufacturing a thin-layer component and a thin-layer component, in particular a thin-layer, high-pressure sensor having a substrate on which at least one functional layer to be provided with contacts is to be deposited.

### BACKGROUND INFORMATION

High-pressure sensors are used in numerous systems in a motor vehicle, for example in direct gasoline injection or common-rail diesel injection. High-pressure sensors are also used in the field of automation technology. The functioning of these sensors is based on converting the pressure-induced mechanical deformation of a diaphragm into an electrical signal with the aid of a thin-layer system. German Published Patent Application No. 100 14 984 already describes such high-pressure sensors, which have thin-layer systems, but can have, in practice, slight layer-adhesion problems in the region of the contact layers and instances of capacitive asymmetry as a result of instances of surface asymmetry of the contact layers caused by manufacturing.

### SUMMARY OF THE INVENTION

The method of the present invention and the thin-layer component of the present invention have the advantage over the background art, that problems with edge coverings and edge tears are prevented and the layer adhesion is improved, since the contact-layer system is deposited on a uniform undersurface, i.e. since no steps or only very small steps to be overcome by the layers are present.

It is particularly advantageous that, because a region of the measuring elements is situated between each region of the contact-layer system and the diaphragm layer, a capacitive symmetry is ensured since the surface and therefore the capacitance of the contacts (relative to the diaphragm layer) are determined by the precisely etched resistive layer, not the less precise contact-layer system deposited into a shadow mask. In addition, the layer adhesion is improved since the contact-layer system is deposited on a uniform undersurface, and not, as up to this point, also at least partially on the insulating undersurface of the diaphragm layer, on which residues deteriorating the adhesion to the undersurface may remain during the etching process of the resistive layer. In addition, there are no steps at all to be overcome by the layers, so that problems with edge coverings or edge tears are effectively prevented.

Furthermore, it is advantageous to etch the resistive layer and a passivation layer jointly, since, in this manner, an increased yield may be achieved by dispensing with a masking level. In addition, the bondability is prevented from being disturbed by residues, which may be formed when a passivation layer is applied through a shadow mask.

In addition, is advantageous that nickel-chromium or nickel-chromium-silicon is used as a material for the resistive layer. This allows the PECVD process step for the deposition of polysilicon as a resistive layer at over 500 [symbol] C to be dispensed with, and instead allows a sputtering process for the deposition of the nickel-chromium or nickel-chromium-silicon to be used, which may already be applied at 130 [symbol] C and lower. In this manner, the maximum process temperature may be reduced markedly.

### BRIEF DESCRIPTION OF THE DRAWINGS

FIG. 1 shows a first manufacturing method according to the present invention.

FIG. 2 shows method steps of a second manufacturing method according to the present invention.

FIG. 3 shows a third manufacturing method according to the present invention.

FIG. 4 shows a method step of a fourth manufacturing method.

FIG. 5 shows method steps of a fifth manufacturing method.

### DETAILED DESCRIPTION

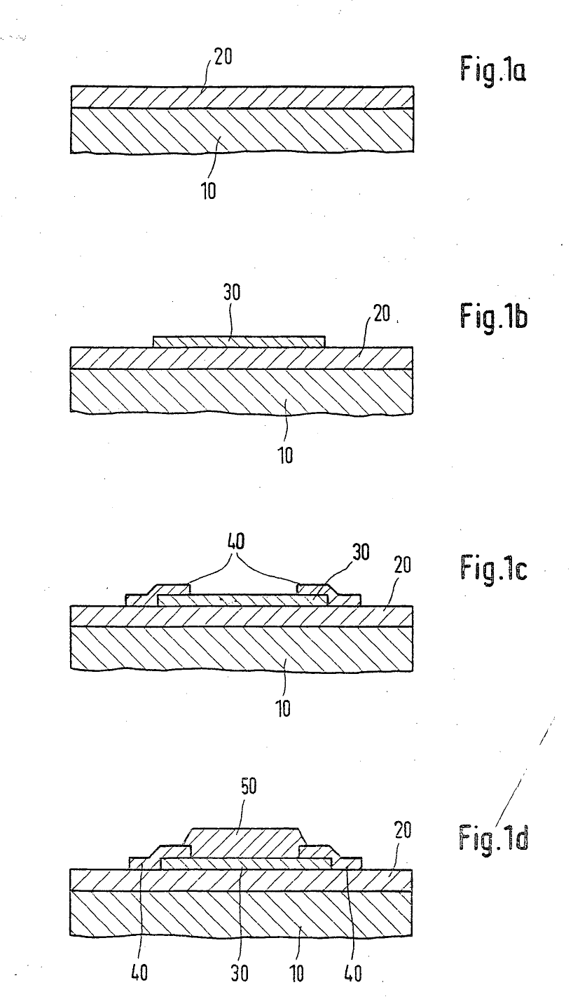

FIG. 1 shows a first method according to the present invention for manufacturing high-pressure sensors. An insulating layer 20 is first deposited onto the entire upper surface of a steel diaphragm 10 to be coated (FIG. 1a). The actual functional layer for strain gauges is then deposited over the entire surface; in a further step, these strain gauges 30 are then fabricated with the aid of a photolithographic patterning step (FIG. 1b). The contact layer or contact layer system 40, which is usually photolithographically patterned as well, is subsequently deposited (FIG. 1c). Shadow-masking technology is also used as an alternative to photolithographically patterning contact layer 40. In order to set the desired electrical properties, a balancing operation is then often performed, in particular for adjusting the symmetry of a Wheatstone bridge formed by several patterned-out, piezoresistive strain gauges or resistive elements. In a further step (FIG. 1d), a passivation layer 50 is deposited, whose patterning is also accomplished either photolithographically or through the use of the shadow-mask technique. When a passivation layer is photolithographically patterned, this is accomplished with the aid of a photoresist mask and a plasma-etching step, in which a CF₄/O₂ gas mixture is preferably used as an etching gas. When the passivation layer is patterned, using the shadow-mask technique, the position of the shadow-mask opening is selected in such a manner, that deposition exclusively occurs at suitable positions or locations.

In a first exemplary embodiment of the present invention, an insulating layer 20 is deposited, as shown in FIGS. 1a and 1b, onto steel diaphragm 10, and a resistive layer is then deposited onto insulating layer 20, and, in a further step, the resistive layer is patterned to form strain gauges or resistive elements 30. For example, a 10 μm thick silicon-oxide layer, which is deposited in a PECVD process (PECVD=plasma enhanced chemical vapor deposition), is used as an insulating layer. A 500 nanometer thick polysilicon layer or a 50 nanometer thick nickel-chromium or nickel-chromium-silicon layer is deposited as a resistive layer, which, in the case of polysilicon, is patterned using a photolithography step and a subsequent plasma-etching step, and, in the case of nickel-chromium or nickel-chromium-silicon, is patterned using a wet-etching step.

In order that, during the subsequent deposition of contact-layer system 40, steps are covered that are small in comparison with the thickness of the contact layer, the present invention provides, in the method shown in FIG. 1, for the resistive layer being formed as an approximately 50 nanometer thick nickel-chromium or nickel-chromium-silicon layer. The contact layer, which is denoted by reference numeral 40 in FIG. 1, is then deposited with the aid of a sputtering or vapor-deposition process. This is either accomplished with the aid of a shadow mask or done over the entire surface with a subsequent photodelineation process, using an ion-beam etching step.

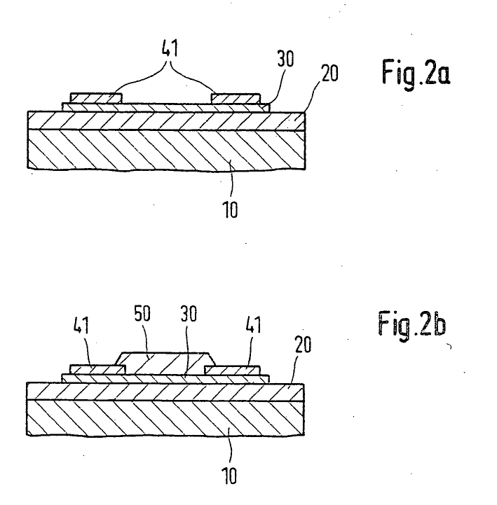

For producing the contact-layer system, a second method of the present invention provides for one to proceed as described in FIG. 2, the contact-layer system being deposited on the measuring elements in such a manner, that no steps are covered: To produce contact-layer system 41, a 500 nanometer thick sequence of layers made up of nickel-chromium, palladium, and then gold is initially sputtered or vapor-deposited through a shadow mask onto strain gauges 30 (FIG. 2a). In this case, the openings of the shadow mask used here are all situated inside the region of the strain gauges patterned beforehand, so that regions of strain gauge 30 are situated at every point of contact-layer system 41 between contact system 41 and steel diaphragm 10. In a further step (FIG. 2b), a 500 nanometer thick passivation layer 50, which is made of silicon nitride (SiₓNi_{y}; x=3, y=4) and protects the function-sensitive regions of strain gauges 30 between the contacts of contact-layer system 41 from external influences, is deposited, in a PECVD process, through an additional shadow mask, in order to ensure trouble-free operation of the sensor element under the field conditions in a motor vehicle.

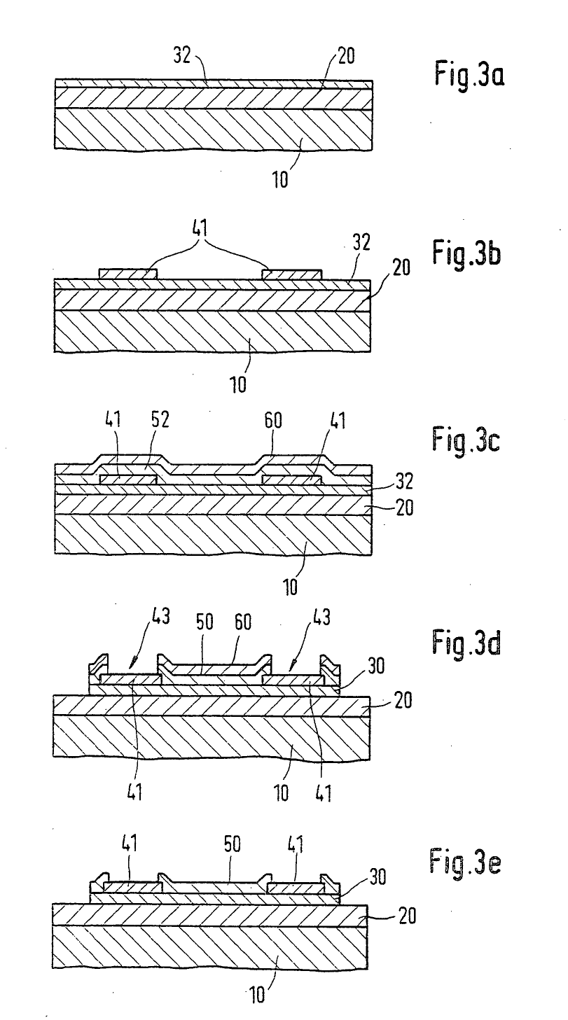

FIG. 3 shows a third method according to the present invention for manufacturing a high-pressure sensor, in which, in a first step (FIG. 3a), a 10 micrometer thick silicon-oxide insulating layer 20 is deposited, in a PECVD process, onto a steel diaphragm 10 on which a resistive layer 32 made of polysilicon (500 nanometer thick) or NiCr (50 nanometer thick) or NiCrSi (50 nanometer thick) is subsequently deposited. In a second step (FIG. 3b), a 500 nanometer thick contact-layer system 41 is deposited, using shadow-mask technology. Nickel or a layer sequence of nickel-chromium, palladium, and then gold is used as a material for this. To produce the contact-layer system, the contact material may alternatively be deposited over the entire surface, and the deposited contact material may then be patterned, using a photolithography step and an etching step. As shown in FIG. 3c, a silicon nitride layer 52 is subsequently deposited over the entire surface, and a photoresist layer 60 is deposited onto it. In order to pattern resistive layer 32 for producing the resistive elements or strain gauges 30, the photoresist is exposed in such a manner, that, during the subsequent development, both inner regions 43 of contact-layer system 41 and edge regions of the sensor may also be exposed or subjected to an etch attack. After the development of photoresist layer 60, the etching-away of silicon-nitride layer 52 in inner regions 43, where inner regions 43 are used as an etch-stopping layer, and the etching-away of both silicon-nitride layer 52 and resistive layer 32 between the contacts of contact-layer system 41 for forming the resistive elements, as well as in the edge regions of the sensor element, the result is a high-pressure sensor, which is still covered by the remaining parts of the photoresist layer, and whose strain gauges 30 are covered by a silicon-nitride passivation layer 50, and whose contact-layer system is underlaid with unremoved regions of resistive layer 32 over the entire surface. In this connection, a plasma-etching process employing a tetrafluoromethane-oxygen mixture is preferably used as an etching method when polysilicon is the resistive material, and a wet-chemical etching process is used as an etching method when NiCr or NiCrSi is the resistive material. In further steps, the contacts of the contact-layer system may be provided with electrical connections, and the upper side of the high-pressure sensor may still be covered, for example, by a housing, after the rest of the photoresist layer is removed (FIG. 3e).

In a procedure (fourth method) that is an alternative to the third specific embodiment represented in FIG. 3, photosensitive BCB (=benzocyclobutene) may be deposited in place of silicon nitride (FIG. 3c) as passivation layer 52. The exposure and development of the photoresist layer and BCB layer may then occur simultaneously, so that, subsequently, the passivation layer no longer has to be etched, but rather just the resistive layer. As shown in FIG. 4, the set-up may then be heated to a temperature of, e.g. 300 [symbol] C after the removal of the photoresist layer, in order to attain a light reflow of the BCB layer and, thus, to also cover the outer edges of strain gauges 30 with passivation layer 55 resulting from the BCB layer.

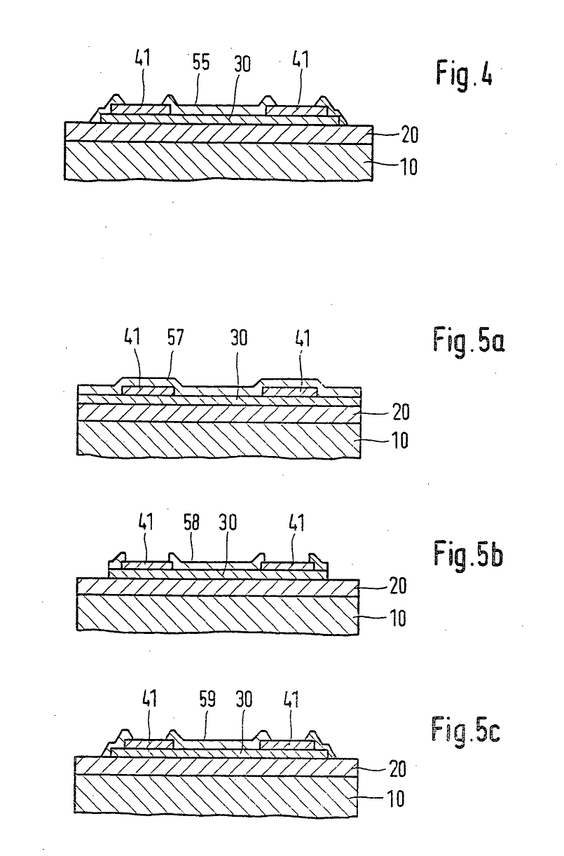

In a fifth manufacturing method, which is a further alternative to the specific embodiment represented in FIG. 3 and employs nickel-chromium as the resistive material, the use of photoresist is completely dispensed with, and, subsequently to a procedure shown in partial FIGS. 3a and b, only a layer 57 of photosensitive BCB material is sprayed or printed onto the entire upper surface of resistive layer 32 or contact-layer system 41 (FIG. 5a). After exposure and development of BCB layer 57, the resistive layer is laid bare in both the edge regions and the region between the contacts, in such manner, that, first of all, desired passivation layer 58 is already formed, and secondly, subsequent, wet-chemical etching of the resistive layer at these exposed locations results in the desired patterning of the resistive layer to form strain gauges 30 (FIG. 5b). It is possible to dispense with a photoresist layer in the case of using NiCr or NiCrSi as a resistive material and in the case of using a wet-chemical etching process, since the BCB layer is resistant to the acid for etching the nickel-chromium or the nickel-chromium-silicon. A subsequent “reflow bake” results, in turn, in the rounding-off of the passivation-layer edges at the contacts and, in particular, in the passivation of the edge regions of strain gauges 30, because of reshaped passivation layer 59 forming.

As described in German Published Patent Application No. 100 14 984, the resistive layer may also be patterned in an alternative manner, using a laser method.

The unit of (stainless) steel diaphragm 10 and insulating layer 20 may optionally be replaced by a glass diaphragm.

In a further alternative, the insulating layer may be made of other organic or inorganic layers, such as “HSQ” (hydrogen silsesquioxane) from Dow Corning, “SiLK” from Dow Chemical, or “Flare” from Allied Signal.

1. A method for manufacturing a thin-layer component, comprising:
depositing a resistive layer for forming a measuring element on an electrically non-conductive surface of a diaphragm layer; and
depositing a contact-layer system for electrically contacting the measuring element on the measuring element in such manner that one of no steps and steps that are small in comparison with a thickness of the contact-layer system are covered.

2. The method as recited in claim 1, wherein:
the thin-layer component includes a thin-layer, high-pressure sensor, and the measuring element includes a strain gauge.

3. The method as recited in claim 1, wherein:
the contact-layer system is deposited on the measuring element in such a manner that a region of the measuring element is situated between each region of the contact-layer system and the diaphragm layer.

4. The method as recited in claim 3 wherein:
the contact-layer system is deposited through an opening of a shadow mask in accordance with one of a sputtering operation and a vapor-deposition operation, and
a position of the opening is selected such that deposition exclusively occurs on the resistive layer.

5. The method as recited in claim 4, wherein:
the resistive layer is initially deposited over an entire surface, and the resistive layer is patterned one of photolithographically and in accordance with a laser operation, so that a lateral expansion of one of the patterned resistive layer and the measuring element is greater, at all locations, than that of the opening in the shadow mask subsequently used for depositing the contact-layer system.

6. The method as recited in claim 5, wherein:
the resistive layer is initially deposited over an entire surface,
the contact-layer system is deposited onto the resistive layer,
a set-up is provided with a passivation layer over the entire surface, and
a patterning of the resistive layer and the passivation layer is subsequently accomplished using only one etching mask.

7. The method as recited in claim 6 wherein:
the etching mask is produced by depositing, exposing, and developing a photoresist layer on the passivation layer.

8. The method as recited in claim 7, wherein:
a material of the passivation layer includes photosensitive BCB so that the passivation layer is simultaneously exposed and developed with the photoresist layer.

9. The method as recited in claim 1, wherein:
the resistive layer includes one of nickel-chromium and nickel-chromium-silicon.

10. The method as recited in claim 6, wherein:
the resistive layer includes one of nickel-chromium and nickel-chromium-silicon, and
a layer of BCB material is used as a passivation layer that is simultaneously used as an etching mask, without additionally depositing a photoresist layer.
